(19) United States
(12) Patent Application Publication
(10) Pub. No.: US 2026/0195337 A1
(43) Pub. Date: Jul. 9, 2026

(54) Information Processing Method And Information Processing Device

(71) Applicant: LegalOn Technologies, Inc., Tokyo (JP)

(72) Inventors: Takafumi MORI, Tokyo (JP); Mike CONTILLO, Tokyo (JP); Takahiko KAI, Tokyo (JP); Akihiko MATSUBA, Tokyo (JP)

(21) Appl. No.: 19/551,686

(22) Filed: Feb. 27, 2026

Related U.S. Application Data
(63) Continuation of application No. PCT/JP2024/012919, filed on Mar. 28, 2024.
(60) Provisional application No. 63/579,085, filed on Aug. 28, 2023.

(51) Int. Cl. G06F 16/25; G06F 16/93; G06F 40/166; G06F 40/197

(52) U.S. Cl. CPC G06F 16/254; G06F 16/93; G06F 40/166; G06F 40/197

(57) ABSTRACT

An information processing method according to an embodiment includes: extracting at least one piece of alert information, based on a support target document, from a first database including a plurality of pieces of the alert information for calling attention of a user based on a first standard regarding a content of a document unit constituting a document; extracting at least one piece of playbook information, based on the support target document, from a second database in which the playbook information is registered, in which the playbook information is for calling attention of a user based on a second standard regarding a content of a document unit constituting a document, and the playbook information is editable in the second database; and generating review information including the playbook information.

### CROSS-REFERENCE TO RELATED APPLICATIONS

This application is a continuation of International Application No. PCT/JP2024/012919, filed on Mar. 28, 2024, which designates the United States, and which claims the benefit of U.S. Provisional Application No. 63/579,085, filed on Aug. 28, 2023. The entire contents of each of the above-identified applications are incorporated herein by reference.

### BACKGROUND

Embodiments of the present disclosure relate to information processing and an information processing device.

Conventionally, a system that supports review of a document has been proposed. For example, a legal sentence evaluation method for evaluating a legal sentence has been proposed. The legal sentence evaluation method is, as disclosed in Japanese Laid-Open Patent Publication No. 2019-212315, implemented by a computer, and includes: an input step of receiving an input of a legal sentence; a reading step of reading evaluation range information related to an evaluation range of the legal sentence and an evaluation rule of the legal sentence; an evaluation step of evaluating at least a range corresponding to the evaluation range information of the legal sentence on the basis of the evaluation rule; and an output step of outputting the evaluation. In such a system, there is a case where automatic review processing is executed using a highly versatile standard registered in advance by a system provider.

### SUMMARY

An information processing method according to an embodiment is an information processing method according to an embodiment including: extracting at least one piece of alert information, based on a support target document, from a first database including a plurality of pieces of the alert information for calling attention of a user based on a first standard regarding a content of a document unit constituting a document; extracting at least one piece of playbook information, based on the support target document, from a second database in which the playbook information is registered, in which the playbook information is for calling attention of a user based on a second standard regarding a content of a document unit constituting a document, and the playbook information is editable in the second database; and generating review information including the playbook information.

### BRIEF DESCRIPTION OF DRAWINGS

FIG. 1 is a schematic diagram for describing an outline of a document browsing support system according to an embodiment.

FIG. 2 is a block diagram illustrating an example of a hardware configuration of an information processing device according to the embodiment.

FIG. 3 is a diagram illustrating an example of functional blocks in a processor of the information processing device of the present embodiment.

FIG. 4A is a diagram illustrating an example of alert display of review information provided to a user, in a terminal device.

FIG. 4B is a diagram illustrating an example of alert display of review information in which alert information created by first review processing and alert information created by second review processing are displayed.

FIG. 5A is a diagram illustrating an example of a GUI (registration GUI) for registering playbook information into a second database for each document segment type by a registration unit.

FIG. 5B is a diagram illustrating an example of a GUI (registration GUI) for registering playbook information into the second database for each document segment type by the registration unit.

FIG. 5C is a diagram illustrating an example of a GUI for searching for and displaying playbook information for each document segment type.

FIG. 6 is a diagram illustrating an example of playbook information registered in the second database.

FIG. 7 is a block diagram illustrating an example of a hardware configuration of the terminal device.

FIG. 8 is a diagram illustrating an example of functional blocks in a processor of the terminal device.

FIG. 9 is a flowchart illustrating an example of a flow of playbook information registration processing.

FIG. 10 is a flowchart illustrating a flow of document browsing support processing including second review processing according to a first example.

FIG. 11 is a flowchart illustrating a flow of the second review processing according to the first example.

FIG. 12 is a flowchart illustrating a flow of second review processing according to a second example.

FIG. 13 is a flowchart illustrating a flow of second review processing according to a third example.

FIG. 14 is a diagram illustrating an example of a GUI at a time of registration of playbook information provided to a user, in the terminal device.

FIG. 15 is a flowchart illustrating an example of a flow of playbook information registration processing according to a second embodiment.

### DESCRIPTION

Hereinafter, embodiments will be described in detail with reference to the drawings. Note that, in the following description, components having substantially the same functions and configurations may be denoted by the same reference signs, and description will be made if necessary. In addition, the embodiments can be combined with other embodiments, modifications, and conventional techniques.

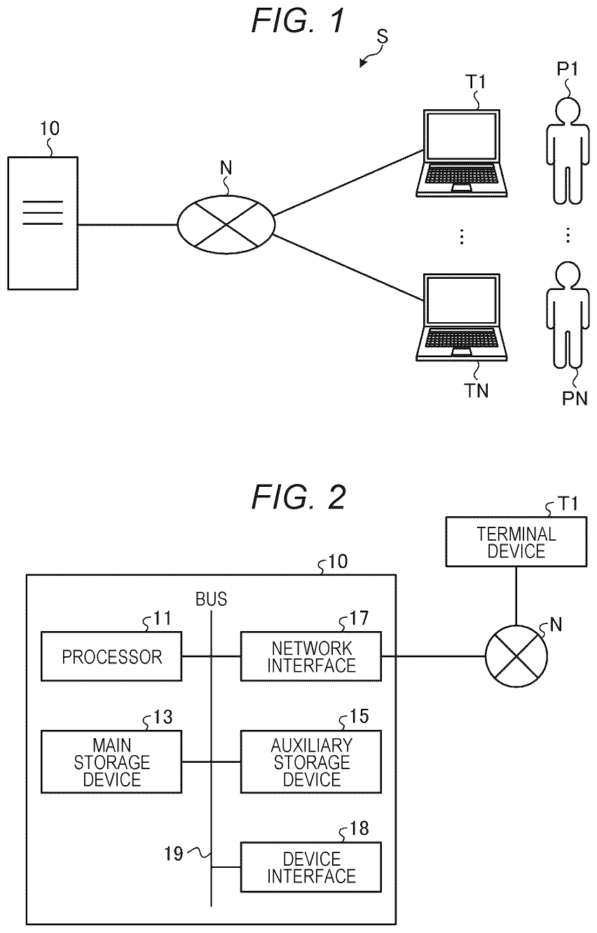

FIG. 1 is a schematic diagram for describing an outline of a document browsing support system S according to the present embodiment. As illustrated in FIG. 1, the document browsing support system S of the present embodiment may function as a support system when a user browses a document, and include, for example, an information processing device 10 according to the embodiment and at least one of terminal devices T1 to TN capable of communicating with the information processing device 10 via a network N. The terminal devices T1 to IN may be operated, for example, by users P1 to PN, respectively. Note that the terminal devices T1 to TN will be described by taking a configuration of the terminal device T1 as an example.

In such review processing, it may be advantageous if the review processing can be executed using not only the highly versatile standard registered in advance but also an individual standard based on an organization, a position, and the like to which a user belongs.

A problem to be solved by the present disclosure or the present embodiment may be to provide a support technology for flexibly implementing document review on a document.

Here, the document browsing support system S according to the present embodiment may be, for example, a system that supports browsing (displaying) of a document on a browser. In the present specification, a document may mean a document in any language, created according to a certain rule or standard such as a certain rule, law, or custom. Document data may be document data in any data format. The document data may be typically text data, but can also include data such as image data or tabular data. In addition, the document or the document data can include meta-information (a version, a creation date, an update date, a creator, an updater, and the like), format information (a decoration such as an underline or a marker, a font, indent, and the like), change history information, comment information, and the like created by document creation software.

Hereinafter, in order to make the description specific, a case where a document handled by the document browsing support system S is a legal document (for example, a contract document) in Japanese will be taken as an example. However, the document handled by the document browsing support system S is not limited to the contract document, and may be, for example, a rule in an organization, and may be, for example, an internal rule in English. In addition, the legal document handled by the document browsing support system S may be described in any language.

In addition, the document browsing support system S according to the present embodiment can have a document creation support function in addition to a document browsing support function. Here, the document creation support function may provide a function of editing (modifying, adding, deleting, and the like) a content of a support target document and information for supporting editing.

Hereinafter, in order to make the description specific, a case where the document browsing support system S may have the document creation support function will be taken as an example. However, it may not be essential for the document browsing support system S to have the document creation support function.

A service (document browsing support service) provided by the document browsing support system S according to the present embodiment can include, for example, at least one of: executing document review processing on a support target document on a web browser and providing a result thereof to a user; executing document editing in response to an instruction from the user; storing an edited document or providing the edited document to the user; editing additional information (for example, meta-information, comment information, chat information, or format information) associated with the support target document; creating a new document (including a copy); comparing a plurality of documents (for example, clearly indicating difference information); automatically proofreading the support target document; and executing various types of processing using a translation display function.

In addition, in the present specification, the document review processing may be, for example, processing of analyzing or evaluating information included in a support target document on the basis of a certain standard and outputting a result thereof. For example, the document review processing includes checking and examining whether or not information included in a support target document may be appropriate on the basis of a certain standard.

Specifically, the document review processing may include, for example, matching between wording in a document and a check list prepared in advance and outputting a result of matching or an indication included in the check list. In addition, editing may mean, for example, adding, deleting, or changing information included in an editing target.

In particular, the document browsing support system S according to the present embodiment can execute first review processing and second review processing as the document review processing. The first review processing and the second review processing will be described later in detail.

The meta-information associated with the support target document may include, for example, at least one of a document ID, a type of document (for example, a type such as a basic transaction contract, a non-disclosure agreement, or a service agreement), a version, a creation date and time, an update date and time, an upload date and time, a creator, an updater, a deadline, and a document ID of a related document.

The comment information associated with the support target document of the present embodiment may be additional information created by at least one user related to creation of the document, and for example, may be associated and managed for each version of the support target document. The comment information associated with the support target document may be a comment created by document creation software.

The chat information of the present embodiment may be, for example, additional information generated by using a chat function for a support target document among a plurality of users related to creation of the support target document, and for example, may be managed in association with a plurality of versions of the support target document. The additional information may be typically text data, but can also include another data format such as an image or voice.

The support target document of the present embodiment may be a document file uploaded from the terminal device, may be a file newly created in the information processing device, for example, by using an online editor, or may be a file already uploaded, stored, and/or edited.

The terminal device T1 of the present embodiment may be a client device managed by the user P1 who uses the document browsing support service. The terminal device T1 may display a document on a screen of a display device, for example, on the basis of information from the information processing device 10. In the present embodiment, using a document review result, an editing screen, or the like displayed on a screen of a display device of the terminal device T1, a user can perform operations on a support target document, such as indent replacement processing, document review reference, comment input, comment reference, chat information input, chat information reference, document editing processing, translation display of the support target document, display of document review information, display of difference information, display of a suggested draft, display of an indicated matter, and document storage.

Next, specific configurations of the information processing device 10 and the terminal device T1 of the present embodiment will be described.

### (Information Processing Device 10)

The information processing device 10 of the present embodiment may be a device that is connected to a client device by communication and performs various types of processing in response to a request from the client device. The information processing device 10 may be, for example, a server device managed by a business operator side that provides a document browsing support service. For example, the information processing device 10 may provide a document browsing support service to the terminal device T1 in response to a document browsing support request received from the terminal device T1 as a client device via the network N. In particular, the information processing device 10 according to the present embodiment may execute the second review processing, the document editing processing, and the like in the document browsing support service.

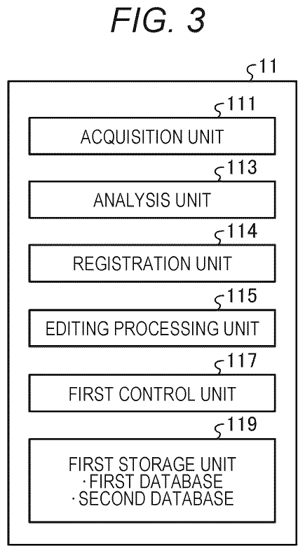

FIG. 2 is a block diagram illustrating an example of a hardware configuration of the information processing device 10 according to the embodiment. As illustrated in FIG. 2, the information processing device 10 of the present embodiment may be a computer, and may include, as an example, a processor 11, a main storage device (memory) 13, an auxiliary storage device (memory) 15, a network interface 17, a device interface 18, and a bus 19 that connects the components to each other.

The information processing device 10 of the present embodiment illustrated in FIG. 2 includes each one component, but may include a plurality of the same components. In addition, one information processing device 10 is illustrated in FIG. 2, but software may be installed in a plurality of computers, and each of the plurality of computers may execute the same part or different parts of processing of the software. In this case, the information processing device 10 may be in a form of distributed computing in which each of the computers communicates via the network interface 17 or the like to execute processing. That is, the information processing device 10 in the present embodiment may be configured as a system that implements various functions described later by one or a plurality of computers executing commands stored in one or a plurality of storage devices.

Various computations of the information processing device 10 of the present embodiment may be executed in parallel processing using one or a plurality of processors or using a plurality of computers via a network. In addition, various computations may be distributed to a plurality of computing cores in the processor and executed in parallel processing. In addition, a part or the whole of the processing, means, and the like of the present disclosure may be executed by at least one of a processor and a storage device provided on a cloud capable of communicating with the information processing device 10 via a network. As described above, the processing of the document browsing support system S in the present embodiment may be in a form of parallel computing by one or a plurality of computers.

The processor 11 may be an electronic circuit (a processing circuit, a processing circuitry, a central processing unit (CPU), a graphics processing unit (GPU), a field programmable gate array (FPGA), an application specific integrated circuit (ASIC), or the like) including a control device and a computing device of the information processing device 10. In addition, the processor 11 may be a semiconductor device or the like including a dedicated processing circuit. The processor 11 may be achieved by an optical circuit using an optical logic element without being limited to an electronic circuit using an electronic logic element. In addition, the processor 11 may have a computing function based on quantum computing.

The processor 11 can perform computing processing on the basis of data and software (program) input from each device or the like of an internal configuration of the information processing device 10, and can output a computation result and a control signal to each device or the like. The processor 11 may control each component constituting the information processing device 10 by executing an operating system (OS) of the information processing device 10, an application, or the like.

The information processing device 10 in the present embodiment may be achieved by one or a plurality of processors 11. Here, the processor 11 may refer to one or a plurality of electronic circuits disposed on one chip, or may refer to one or a plurality of electronic circuits disposed on two or more chips or two or more devices. When a plurality of electronic circuits are used, the electronic circuits may communicate in a wired or wireless manner.

The main storage device 13 of the present embodiment may be a storage device that stores commands executed by the processor 11, various types of data, and the like, and information stored in the main storage device 13 is read by the processor 11. The auxiliary storage device 15 may be a storage device other than the main storage device 13. Note that each of these storage devices means any electronic component capable of storing electronic information, and may be a semiconductor memory. The semiconductor memory may be either a volatile memory or a nonvolatile memory. A storage device for storing various types of data used in the information processing device 10 according to the present embodiment may be achieved by the main storage device 13 or the auxiliary storage device 15, or may be achieved by a built-in memory built in the processor 11. For example, a storage unit in the present embodiment may be achieved by the main storage device 13 or the auxiliary storage device 15.

To one storage device (memory), a plurality of processors may be connected (coupled), or a single processor 11 may be connected. A plurality of storage devices (memories) may be connected (coupled) to one processor. When the information processing device 10 in the present embodiment includes at least one storage device (memory) and a plurality of processors connected (coupled) to the at least one storage device (memory), at least one processor among the plurality of processors may be connected (coupled) to the at least one storage device (memory). In addition, this configuration may be achieved by a storage device (memory) included in a plurality of computers and the processor 11. Furthermore, a storage device (memory) may be integrated with the processor 11 (for example, a cache memory including an L1 cache and an L2 cache).

The network interface 17 of the present embodiment may be an interface for connecting to the network N in a wireless or wired manner. As the network interface 17, it may be only required to use an appropriate interface such as one conforming to an existing communication standard. The network interface 17 may exchange information with an external device connected via the network N. Note that the network N may be any of a wide area network (WAN), a local area network (LAN), a personal area network (PAN), and the like, or may be a combination thereof, and only needs to be one that allows exchange of information between the information processing device 10 and an external device. Examples of the WAN may include the Internet, examples of the LAN include IEEE802.11 and Ethernet (registered trademark), and examples of the PAN may include Bluetooth (registered trademark) and near field communication (NFC).

The device interface 18 of the present embodiment may be an interface such as a universal serial bus (USB) directly connected to an output device such as a display device, an input device, and an external device. In addition, the external device may be a storage such as a storage device (memory), a network storage, or an HDD. In addition, the external device may be a device having some functions of components of the information processing device 10 in the present embodiment. That is, the information processing device 10 may transmit or receive a part or the whole of a processing result of the external device.

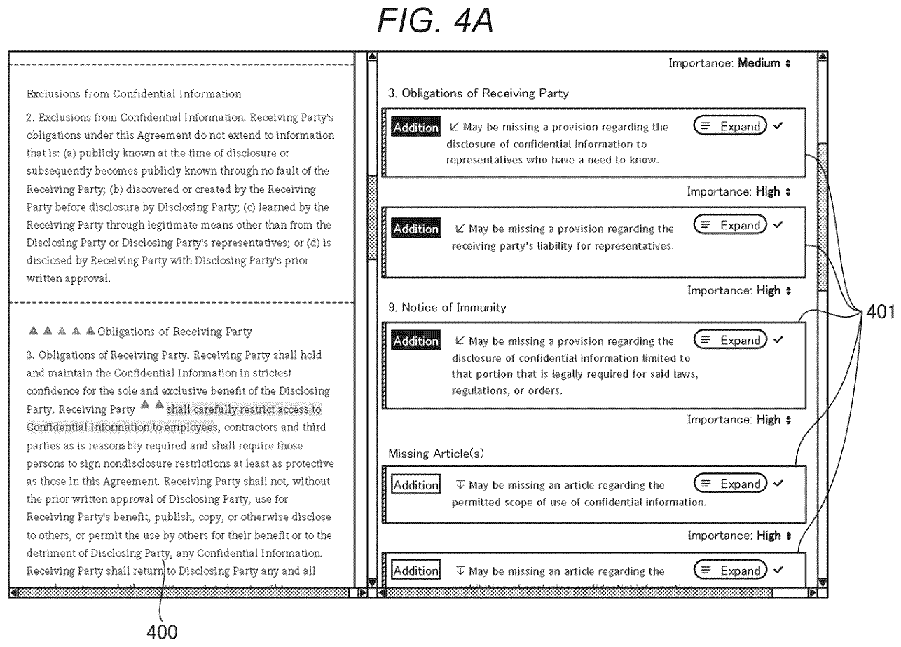

FIG. 3 is a diagram illustrating an example of functional blocks of the present embodiment in the processor 11. The processor 11 may include, for example, an acquisition unit 111, an analysis unit 113, a registration unit 114, an editing processing unit 115, a first control unit 117, and a first storage unit 119, as functions implemented by the processor 11. Functions implemented by the acquisition unit 111, the analysis unit 113, the registration unit 114, the editing processing unit 115, the first control unit 117, and the first storage unit 119 may be stored individually as programs in, for example, the main storage device 13, the auxiliary storage device 15, or the like. By reading and executing the programs stored in the main storage device 13, the auxiliary storage device 15, or the like, the processor 11 can implement functions related to the analysis unit 113, the registration unit 114, the editing processing unit 115, the first control unit 117, and the first storage unit 119.

For example, the acquisition unit 111 of the present embodiment may acquire DOCX-format document data as a support target document via the network N. In addition, for example, the acquisition unit 111 may acquire DOCX-format document data stored in the first storage unit 119 as a support target document. In addition, for example, the acquisition unit 111 may acquire DOCX-format document data stored in a storage unit of another device as a support target document via the network N.

For example, the analysis unit 113 of the present embodiment may execute document review processing using document data of a support target document received from the acquisition unit 111. That is, the analysis unit 113 of the present embodiment may execute the first review processing and the second review processing, and generate document review information regarding document data. Note that the document review information is an example of analysis information.

In addition, the document review information generated by the document review processing executed by the analysis unit 113 of the present embodiment may be based on, for example, information obtained by analyzing a document on the basis of a rule or a standard applied to the document (for example, a certain rule, law, or custom). Examples of review information of a contract document as in the present embodiment include: (1) an indication as to whether an article included in a document (a contract document in the present embodiment) is advantageous or disadvantageous to a user (party); (2) an advice regarding correction and deletion of the article included in the contract document; (3) an indication that an item that should be usually included in the contract document is missing, and suggestion of an item to be added; and (4) information on the importance and the degree of recommendation of an item of each review result. The (document) review information exemplified in the above (1) to (4) and the like may be referred to as contract review information when the support target document is a contract document. By using the above information, a user can easily grasp a legal risk included in the contract document and review a contract including correction proposal. In addition, format information indicating, for example, whether a format of a sentence meets a standard, and whether a prescribed term is used may also be included.

In addition, the document review processing executed by the analysis unit 113 may include processing of extracting a risk included in the support target document (risk check processing). Here, the risk check processing may be, for example, to determine, using data of a contract document (hereinafter, also referred to as “risk management target document”) that is a support target for which a contract is agreed among a plurality of contracting parties (a company A and a company B in the case of the present embodiment) and data of a document (hereinafter, also referred to as “reference document”) that is a reference for a contract in one of the contracting parties (a company A in the case of the present embodiment), a risk (residual risk) for one of the contracting parties remaining in the risk management target document, and to present a result thereof to a user. Note that risk information data including the result of the risk check is an example of the document review information.

A risk to be checked by the risk check processing may include, for example, a risk assumed from an article, an expression, and wording that are included in the reference document but are not included in the risk management target document, a risk (hereinafter, also referred to as an “unchecked risk”) assumed from an article, an expression, and wording that are not included in the reference document but are included in the risk management target document, a risk assumed from an article, an expression, and wording that are included in both the reference document and the risk management target document, and a risk assumed due to presence of an article, an expression, and wording that are not included in the reference document or the risk management target document.

The analysis unit 113 may extract, for example, information that is included in a document (document data) and is necessary for generating review information. Various techniques can be adopted as a method for extracting information from the document data. For example, keyword search of the document data may be performed, and a character, a number, and the like included in the vicinity of the keyword may be extracted. In addition, information can also be extracted by morphological analysis, syntax analysis, semantic analysis, or context analysis. Furthermore, information may be extracted by natural language processing using machine learning. In addition, prior to the processing, information necessary for document review, such as text data, may be extracted from received document data, or processing of extracting text data from image data may be performed by processing such as OCR. Note that the document review processing may be performed on the received document without extracting information necessary for generating the document review information as described above.

Note that the generation of the document review information executed by the analysis unit 113 can adopt various techniques. For example, the document review information may be generated on a rule basis using the extracted information. In addition, it is also possible to use a learned model that receives the extracted information as an input and outputs corresponding document review information. Furthermore, it is also possible to adopt a combination of a rule-based method and a learned model. In addition, before the generation of the document review information, the document may be divided into sections, paragraphs, items, and the like in units. The units of the division may correspond to a document unit.

In addition, the analysis unit 113 can generate document review information according to a position of a user (party) by using meta-information associated with the support target document. Furthermore, the analysis unit 113 can also generate the document review information by referring to a content of another document (another version of the support target document, another contract document relevant to the support target document, and the like). The meta-information may include information given to a document file itself of a creator or the like of the document and information given by a user or the like by being input separately from the file.

The review information generated by the analysis unit 113 may be displayed on, for example, a display unit of the terminal device T1 in a display form of alert display.

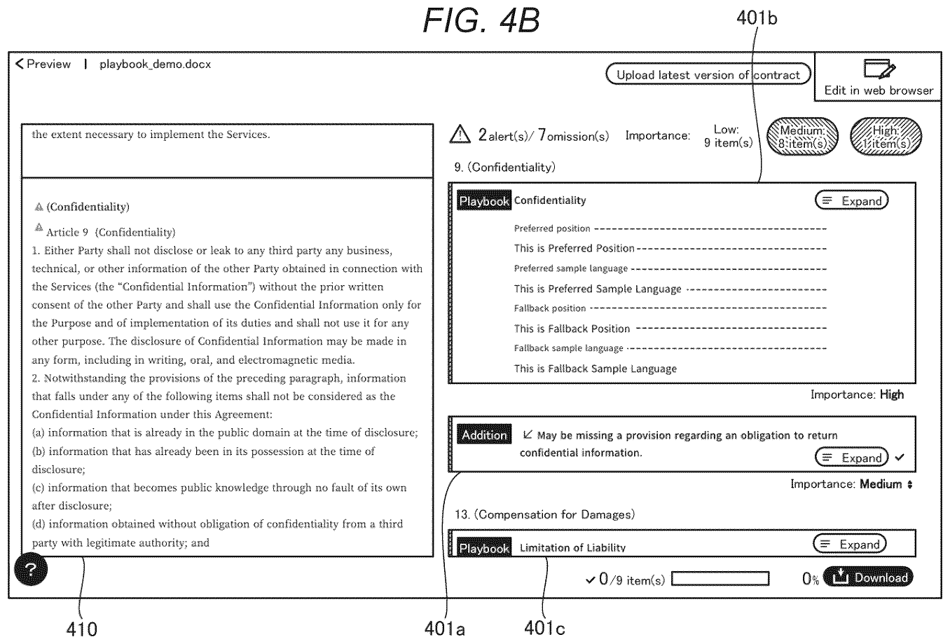

FIG. 4A is a diagram illustrating an example of alert display of review information provided to a user, in the terminal device T1. In FIG. 4A, a support target document 400 is displayed on the left side, and pieces of alert information 401 for attracting user's attention to the review information are displayed on the right side, in a form of being associated with each other by a provision type “Obligation of Receiving Party”, for example, and having positions corresponding to each other. Each piece of alert information 401 may include importance of an indicated content thereof. In the present embodiment, the document unit may be units of sections.

Here, the first review processing and the second review processing executed by the analysis unit 113 will be described. The first review processing may be, for example, review processing executed on the basis of a highly versatile standard (first standard) prepared by a providing side of the document browsing support service. The first review processing may be executed using, for example, a database (first database) or a learned model created by the providing side of the document browsing support service.

Whereas, in the second review processing, for example, review processing may be executed on the basis of a unique (individual) standard (second standard) on a receiving side of the document browsing support service. The unique standard of the receiving side of the document browsing support service may be defined by, for example, a playbook. Here, the playbook may be a material including information to be considered when an organization or an individual who receives the document browsing support service reviews a support target document, for example, and include reference information such as meaning and spirit of each definition, a handling policy, and a handling example. In the present embodiment, various types of information included in the playbook may be also referred to as “playbook information”. The second review processing may be executed using, for example, a database (second database) or a learned model created using the playbook by the receiving side of the document browsing support service. In the present specification, the standard may include a determination standard for determining whether or not to output review information (alert information), and review information to be output in a case where it is determined by the determination standard to output review information.

In the second standard review processing of the present embodiment, whether or not to output alert information may be based on the same determination standard as the first standard. That is, the first review processing based on the first standard and the second review processing based on the second standard may be both executed on the basis of a type of a document unit generated from the support target document, and the review information extracted as a result may be output as the alert information. The alert information may also include reference information of the second standard. Note that the determination standard of the second standard may be a standard different from the first standard. For example, while the first standard is based on other than the type of the document unit (for example, words), the second standard may be based on the document unit.

The second standard may be preferably set to display the alert information on the basis of a determination standard similar to the first standard, that is, to display the alert information when an alert is issued based on the first standard. Since the first standard is provided by the provider of the system, the standard of determination may often be already tuned. Therefore, by setting the second standard in accordance with the first standard, it may be possible to easily set to display necessary review information with high accuracy. In a case where first review information is displayed at the same time as the reference information, a content of the reference information can be a content that supplements, replaces, or cancels information displayed based on the first standard.

In addition, whether or not to output alert information by the review processing of the second standard can be based on, for example, a standard different from that for outputting alert information by the review processing of the first standard. For example, in a case where, in the first review processing, whether or not to output a review result may be determined on the basis of both an alert appearance condition and a classification (hereinafter, may be referred to as a provision type) that is given to a certain document unit and indicates meaning of the certain document unit, in the second review processing, the playbook can be always displayed when the provision type matches regardless of the alert appearance condition.

In addition, whether or not to output alert information by the second standard review processing can also be determined, for example, on the basis of a corresponding provision type. More preferably, whether or not to output alert information by the second standard review processing may be set on the basis of a type of document and the corresponding provision type. By setting a standard for each provision type that is relatively easily detected by a machine learning model or the like trained by a system provider, it may be possible to display necessary review information with high accuracy. In addition, even in a case where alert information is not set for a certain provision type and alert information is not output in the first standard, second review information can be set for that provision type, and the second alert information can be output in a case where a document unit classified as the provision type is included or is not included in a support target document.

Note that the second standard may not be related to the first standard. In that case, the determination can be achieved by creating a unique rule (for example, a certain term is included or not included) or a machine learning model learned so as to be determinable on the basis of the second standard set by the user.

When the first review processing is executed, the alert information 401 illustrated in FIG. 4A may be generated on the basis of the first database or the like created by the providing side of the document browsing support service. By checking the alert information 401 created by the first review processing, the user can appropriately grasp a general risk or the like included in the support target document 400.

In addition, when the first review processing and the second review processing are executed, the alert information 401 illustrated in FIG. 4A may be generated on the basis of the first database or the like created by the providing side of the document browsing support service and the second database or the like created by the receiving side of the document browsing support service including the user using the playbook. At this time, information allowing identification as to whether alert information is alert information based on the first standard or alert information based on the second standard can be given to each piece of the alert information 401 illustrated in FIG. 4A. By checking the alert information 401 created by the second review processing, the user can grasp a risk or the like included in the support target document 400 on the basis of an individual content of the user or the like.

The registration unit 114 may register playbook information into the second database of the first storage unit 119 on the basis of information acquired by the acquisition unit 111. Specifically, the registration unit 114 may associate playbook information input from the user or classified by the learned model with a document segment type, register the playbook information into the second database of the first storage unit 119, and edit the second database. Here, the document segment type indicates a content in each unit when a document may be divided into document segments (document units) such as items, paragraphs, and sentences. For example, in a case where the document is a contract document, the document segment may be a section, a paragraph, and an item, and the document segment type (for example, a provision type) indicates a title (a content of the provision) such as “Definition of Term”. The registration by the registration unit may be performed by, for example, uploading data (for example, a tabular file) including necessary information, in addition to inputting from a screen to be described later. As a result, a plurality of pieces of playbook information can be collectively registered, and convenience of the user is enhanced. In addition, in a case where the playbook information to be used by the user is stored in a tabular format, the convenience may be further enhanced.

FIG. 4B is a diagram illustrating an example of alert display of review information in which alert information 401a created by the first review processing and alert information 401b and 401c created by the second review processing are displayed. As illustrated in FIG. 4B, both the alert information 401a created by the first review processing and the alert information 401b and 401c created by the second review processing of the present embodiment may be displayed in association with a target provision. That is, in the example of FIG. 4B, the alert information 401a created by the first review processing and the alert information 401b created by the second review processing may be displayed aligned with each other for one provision 410 of “Confidentiality”. In addition, the alert information 401c created by the second review processing may be displayed in association with “Compensation for Damages” which is a provision different from “Confidentiality”. Moreover, in the provision of the support target document 410, an icon indicating that alert information may be displayed for the provision is displayed. The alert information created by the second review processing of this example may include a preferred position, a preferred language clause, a fallback position, a fallback language clause, and the like regarding a content of a document unit.

In addition, in the present embodiment, “Addition” which is information indicating that the alert information 401a is created by the first review processing may be added to the alert information 401a, while “Playbook” which is information indicating that the alert information 401b and 401c are created by the second review processing is added to the alert information 401b and 401c. The user can quickly grasp which provision the displayed alert information corresponds to, and whether the displayed alert information has been created by the first review processing or the second review processing.

The example of FIG. 4B may illustrate a case where both alert information created by the first review processing and alert information created by the second review processing are displayed. Whereas, it may be also possible to perform setting to display only the alert information created by the first review processing or only the alert information created by the second review processing.

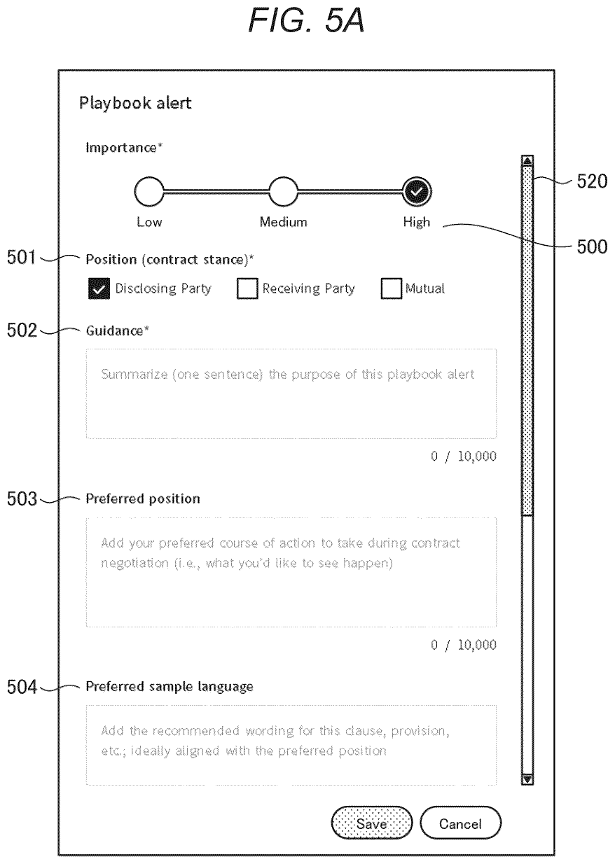

FIGS. 5A and 5B are diagrams illustrating examples of a GUI (registration GUI) for registering playbook information into the second database by the registration unit 114 for each document segment type, and are examples of inputting the playbook information using an alert information setting screen (Playbook alert). The registration GUI illustrated in FIGS. 5A and 5B can be registered, for example, for each document segment type constituting a target provision. As a result, it may be possible to input or register the playbook information with a less load on a user's operation. Note that, in the present embodiment, when a scroll bar 520 is moved downward from the state of the registration GUI illustrated in FIG. 5A, the state of the registration GUI illustrated in FIG. 5B may be obtained.

As illustrated in FIGS. 5A and 5B, for example, items such as an importance setting area (Importance) 500, a position (Position) 501, a guidance (Guidance) 502, a preferred position (Preferred position) 503, a preferred language clause (Preferred sample language) 504, a fallback position (Fallback position) 505, and a fallback language clause (Fallback sample language) 506 may be displayed as the registration GUI.

The importance setting area 500 may be, for example, an item for setting importance of each piece of playbook information added for each document segment type. In the example of FIG. 5A, setting may be made in three stages of “LOW”, “Medium”, and “High”. However, without limiting to this example, for example, a form of a slider bar, directly inputting a number, or the like may be used.

The position 501 may be an item indicating, for example, a user's position when reviewing a document. For example, in a case where a contract type is “Non-Disclosure Agreement”, this item may specify a position such as a disclosing party or a receiving party. By setting this item, alert information can be appropriately displayed for a risk or the like included in a document, which varies according to the user's position.

The guidance 502 may be, for example, an item for entering a standard, a spirit, an interpretation method, and notes of an article. A table or an image can be input to the guidance 502 as necessary.

The preferred position 503 may be, for example, an item for entering a preferred action policy and the like in contract negotiation.

The preferred language clause 504 may be an item for entering recommended wording such as, for example, a corresponding article and rule.

The fallback position 505 may be, for example, an item for entering a fallback action policy or the like in contract negotiation.

The fallback language clause 506 may be, for example, an item for entering wording that would be recommended when a fallback is made for a corresponding article or rule.

The user can register each item constituting playbook information via the registration GUI illustrated in FIGS. 5A and 5B. Note that the registration via the registration GUI may be performed by input or editing of wording or selection from prepared options. For the items included in the first standard (for example, “Position” described later), it may be preferable to prepare and display predetermined options such as radio buttons and a pull-down menu such that the user can select the items, allowing alert information to be appropriately displayed.

FIG. 5C is a diagram illustrating an example of a search screen (search GUI) for searching for playbook information registered in the second database for each document segment type.

As illustrated in FIG. 5C, for example, an alert information list 402, a document type (contract type: Contract type) 404, a user's position (Your position) 405 related to the document, such as a document disclosing party, a playbook add button 406, an importance setting area 407, a first information area 408, and a second information area 409 may be displayed as the search GUI for the playbook information.

The alert information list 402 of the present embodiment may display a list of alert information classified for each document segment type (each provision type in the present embodiment) into which the document unit is classified. By using the alert information list 402, the user can check all the alert information registered for each provision type.

The document type (contract type: Contract type) 404 of the present embodiment may be an item for specifying a type of a document to which playbook information is applied. In the present embodiment, the document to which playbook information is applied may be a contract document, and a case where “Non-Disclosure Agreement” is selected as the document type (contract type: Contract type) 404 is taken as an example.

The user's position (Your position) 405 of the present embodiment may be an item indicating a user's position when reviewing a document. For example, in a case where the contract type 404 is “Non-Disclosure Agreement”, this item may specify a position such as a disclosing party or a receiving party. By setting this item, alert information can be appropriately displayed for a risk or the like included in a document, which varies according to the user's position.

The playbook add button 406 of the present embodiment may be a button for instructing addition (registration) of new playbook information for each document segment type. As illustrated in FIG. 5C, for example, the playbook add button 406 may be provided for each document segment type (each provision type) such as “Confidential Information” and “Use of Confidential Information only for the Purpose”. For example, by pressing the playbook add button 406 provided corresponding to “Confidential Information”, the user can make a transition to a registration screen on which the registration GUI illustrated in FIGS. 5A and 5B is displayed.

The importance setting area 407 of the present embodiment may be an item for displaying importance of each piece of playbook information that has been searched for and selected by the user. In the example of FIG. 5C, setting may be made with display similar to radio buttons in three stages of “Low”, “Medium”, and “High”. However, without limiting to this example, a form of a slider bar, displaying a number, or the like may be used.

The first information area 408 of the present embodiment may be an area for displaying a language clause of playbook information searched for. The user can input any information as text information into the first information area 408.

The second information area 409 of the present embodiment may be an area in which guidance of the searched playbook information is displayed.

In playbook information of the present embodiment, for example, information indicating an update date and time or a user who has updated may be automatically recorded for each piece of playbook information. Note that, the document type (contract type: Contract type) 404, the user's position (Your position) 405 related to a document, such as a document disclosing party, and the update date and time may be meta-information (playbook meta-information) indicating attributes of playbook information. In addition, the playbook meta-information may include: a scope of disclosure such as “Limited to Legal Organization”; “Filtering Setting” for stepwisely selecting information to be displayed; “Recommended Provision” which is a provision related to playbook information and is advantageous for the position of the user; “Other Provision” which is a provision related to playbook information and is advantageous for the other party's position; “Disclosure Status”; and “Comment Information” in which a free comment can be input as text information.

The user can search for desired playbook information by inputting at least one item on the search GUI.

For example, the registration unit 114 may register playbook information into the second database of the first storage unit 119 on the basis of information input via the GUI illustrated in FIGS. 5A and 5B.

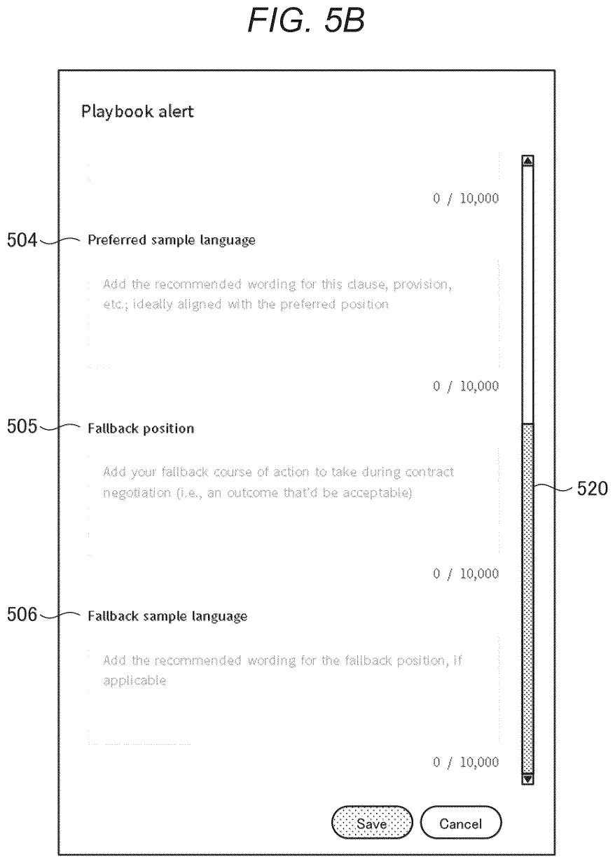

FIG. 6 is a diagram illustrating an example of the playbook information registered in the second database of the first storage unit 119. In FIG. 6, the item “Provision ID” may be an ID corresponding to the document segment type “Confidential Information” illustrated in FIG. 5C, which is a “Provision type (document segment type)”.

The item “Playbook ID” of the present embodiment may be a unique ID for identifying each piece of playbook information.

In the item “Playbook” of the present embodiment, for example, information input to a first information area 504 and a second information area 502 illustrated in FIG. 5A may be registered as a content of playbook information.

In the item “Position” of the present embodiment, for example, information selected in the user's position (Your position) 501 illustrated in FIG. 5A may be registered.

In the item “Contract Type” of the present embodiment, for example, a document type (in the present embodiment, contract type: Contract type, which is an example of a document type) such as “Non-Disclosure Agreement” illustrated in FIG. 5C is registered. For example, in a case where the document type (contract type) is registered from the screen of FIG. 5C, information selected in the display field 404 of the contract type may be registered in FIG. 5C. In a case of registration from the screen of FIGS. 5A and 5B, for example, a predetermined document type may be selected and registered, or a document type of a support target document displayed or selected on the screen before transitioning to the screen of FIGS. 5A and 5B may be registered. Note that the document type is an example of the playbook meta-information.

In the item “Importance” of the present embodiment, for example, importance set in the importance setting area 407 illustrated in FIG. 5A may be registered. Note that the importance is an example of the playbook meta-information.

The analysis unit 113 of the present embodiment may refer to the second database illustrated in FIG. 6 and execute the second review processing. That is, for example, when the provision ID “1” (that is, the document segment type) is “Confidential Information”, the analysis unit 113 may generate review information including playbook information associated with the provision ID “1” in accordance with the second database illustrated in FIG. 6 for the document segment type “Confidential Information”, and display the review information as alert information.

The editing processing unit 115 of the present embodiment may convert a data format of the support target document (document data) received via the first control unit 117 to generate editing data. For example, the editing processing unit 115 may convert document data of a “DOCX” format file as the support target document received via the acquisition unit 111 from an XML format to a “JSON” format to generate editing data.

In addition, the editing processing unit 115 of the present embodiment may executes editing processing on the editing data in response to an editing instruction received from the terminal device T1 via the acquisition unit 111. Here, the editing processing executed by the editing processing unit 115 may include adding, deleting, and changing information included in the editing data. More specifically, the editing processing may include adding, correcting, and deleting a word, a sentence, and a character decoration (for example, a font, a color of a character, a size of a character, a thickness of a character, an underline, or a strikethrough) with respect to the editing data.

In addition, the editing processing executed by the editing processing unit 115 can include format editing processing, word input assisting processing, draft suggesting processing, indicated matter extraction processing, and difference information extraction processing.

Here, the format editing processing may be, for example, processing of correcting a format of editing data as a document. For example, indent, a line head of itemized writing, right-alignment/left-alignment, deviation of an article number, and the like may be preferably automatically corrected with a system by the format editing processing. For example, the editing processing unit 115 may refer to format information of the support target document corresponding to the editing data, and execute format editing processing on the editing data on the basis of the format information.

Setting of a format as a document may be preferably stored in advance in the information processing device 10, a terminal, or the like on the basis of the type of the support target document such as a contract document. For example, in a case of a legal document such as a contract document or an internal rule, setting may be performed such that sections, paragraphs, and items are arranged in this order and in an ascending order of article numbers, and indent is larger in order of sections, paragraphs, and items. In addition, the editing processing unit 115 may execute format editing processing according to a type on the basis of the meta-information of the support target document. Note that this format setting may be created by a user, may be provided as a part of the document browsing support service, or may be created by the user customizing the provided setting. In addition, format setting of the support target document may be interpreted, and may be created on the basis of the interpretation.

The word input assisting processing of the present embodiment may be processing of assisting input, for example, by presenting a candidate word or phrase to be input next at the time of editing document data. As a result, it may be possible to support user's input operation at the time of editing and to reduce a workload. For example, a word or the like that frequently appears can be presented as an input candidate according to the type of the support target document. In addition, the support target document stored by a user or an organization to which the user belongs may be analyzed, and a word or the like that is often used may be presented. In addition, a user may set a word or a phrase. The editing processing unit 115 can determine an input candidate word according to a type on the basis of the meta-information of the support target document. A word or the like presented in the input assisting processing may be displayed, for example, in a predetermined window (in a document editing window) of a screen.

The draft suggesting processing of the present embodiment may be, for example, processing of displaying a draft of an input candidate at the time of editing. For example, when the document is a contract document, a correction sentence example based on at least a part of a correction content of the contract document is read from a database in which a provision draft example may be accumulated and presented as a draft candidate. As a result, it may be possible to support user's input operation at the time of editing and to reduce a workload.

As the draft suggesting processing, the editing processing unit 115 may present a predetermined draft candidate, may present a draft candidate determined by a user or a provider of the document browsing support service, may present a draft candidate generated by a sentence generation service inside or outside the present system using a large language model (LLM) or the like, or may present a draft candidate frequently appearing according to the type of the support target document. In addition, among drafts included in a document stored by a user or an organization to which the user belongs, a draft that is more frequently used than other drafts or a draft that is highly evaluated by the user, a customer including the user, or the like may be presented as a draft candidate. When there are a plurality of draft candidates, at least one draft candidate can be further selected on the basis of an adoption ratio of a provision (a ratio at which a proposed provision is selected by a user) and an adoption frequency in the past document browsing support service, and a candidate with a higher adoption ratio can be preferentially presented to the user. Note that the draft candidate to be presented can be presented as, for example, document review information or other information.

The editing processing unit 115 can also edit the editing data in response to the editing instruction based on the presented draft candidate, for example, an instruction by a drag and drop operation. This presented draft sentence may be displayed in association with a corresponding portion of the document in position. For example, the draft candidate may be displayed close to the corresponding portion of the document. With such display, it may be possible to compare the draft candidate and the corresponding portion of the document with less movement of a line of sight, and it may be possible to reduce a load on a user. In addition, a part of the editing data may be replaced with a presented draft candidate automatically or in accordance with a user's instruction. At that time, in order to clearly indicate what kind of editing has been made, it may be preferable to attach a correction history to the editing data.

Indicated matter extraction processing of the present embodiment may be, for example, processing of presenting, to a user, an indicated matter (for example, document review information, comment information, chat information, a correction history for the editing data, or a comment on document data created by a function of document creation software) related to the support target document. For example, the editing processing unit 115 of the present embodiment may present the extracted indicated matter to a user in a predetermined display form. The indicated matter may be preferably displayed as a list in an area that does not overlap with a portion of the document indicated by the indicated matter, for example, a document review area displayed side by side with an editing area or an independent (individual) window such as a pop-up window.

In addition, by a combination of the indicated matter extraction processing and the draft suggesting processing, the indicated matter and a draft candidate that can resolve the indicated matter may be proposed. At this time, the indicated matter and the draft candidate may be preferably displayed in association with an indicated portion of the document in position. For example, the indicated matter and the draft candidate may be preferably displayed close to a corresponding indicated matter. With such display, it may be possible to compare the indicated matter, the draft candidate, and the corresponding portion of the document with less movement of a line of sight, and it may be possible to reduce a load on a user.

In addition, for a document review area, a pop-up window, and the like in which the indicated matter and the draft candidate are displayed, folding display, minimization display, change in display size, and the like can be executed. As a result, a user can arrange a document display screen having a limited size such that the user can easily see the document display screen, for example, by aligning the document display screen with the indicated portion of the document. In addition, on the basis of the height of the indicated matter or the draft candidate, provisions may be displayed at a wider interval in an editing area. With such display, it may be possible to more clearly and simply indicate a correspondence relationship among the indicated matter, the draft candidate, and the indicated portion of the document.

The difference information extraction processing of the present embodiment may present difference information between two pieces of document data, for example, the support target document data before correction and the corrected document data to a user. For example, the editing processing unit 115 of the present embodiment may extract difference information from the support target document data before correction and the corrected document data, and may present the difference information to a user in a predetermined display form, for example, by displaying the difference and the other portion (that is, the same portion) differently, for example, by emphasis display or highlighting.

The editing processing unit 115 of the present embodiment may execute the above-described various types of editing processing in response to an editing instruction received from the terminal device T1. In addition, the editing processing unit 115 of the present embodiment may convert a data format of the support target document data or the translation data in response to a storage instruction received from the terminal device T1 to generate document data to be a next version of the support target document. For example, in response to a download instruction or a storage instruction received from the terminal device T1, the editing processing unit 115 can generate document data in a “DOCX” format to be a next version of the support target document using support target document data in a “JSON” format.

The first control unit 117 of the present embodiment may perform information communication with the terminal device T1 via the network. Specifically, for example, the first control unit 117 may receive document data transmitted from the terminal device T1 and various instructions such as a document review instruction, an editing instruction, a translation instruction, a storage instruction, and an output instruction (for example, a download instruction). In addition, the first control unit 117 may transmit editing screen information (including information for executing editing processing on the terminal device T1 side) to the terminal device T1. The first control unit 117 may receive information including document data after editing processing from the terminal device T1.

The first control unit 117 of the present embodiment may generate layout information in the document editing processing. The layout information in the document editing processing may be, for example, information for displaying editing data in a predetermined form on a browser screen of the terminal device T1. In addition, the first control unit 117 of the present embodiment may generate layout information in the document review processing. The layout information in the document review processing may be, for example, information for displaying document review information generated by the document review processing and a support target document in association with each other in a predetermined form on the browser screen of the terminal device T1.

The layout information may associate the document review information (including translated information) generated by the document review processing and the support target document with each other in position. Note that association with each other in position may refer to, for example, associating positions to be displayed so as to be browsed by a user, and specifically mean associating the positions on a screen, for example, in units of articles, in units of paragraphs, or in units of sentences. Associating the positions may include, for example, displaying corresponding portions closer to each other in a height or width direction than the other portions, and more preferably, displaying the corresponding portions side by side on a screen. In addition, when additional information may be displayed together, the layout information may include information for associating the additional information with the document review information and the editing data in position.

The layout information may be generated by any method. For example, for a word or a phrase included in the document review information, the degree of coincidence may be scored for each position (for example, each position in units of articles or each position in units of paragraphs) in editing data by a search function, and the layout information may be generated such that the document review information is displayed corresponding to a position with the highest score. In addition, for example, by assigning coordinates in units of articles or in units of paragraphs of editing data and associating the coordinates with corresponding document review information, it may be also possible to associate the display positions of the articles and the paragraphs with the display positions of the document review information.

The first control unit 117 of the present embodiment may transmit various types of information such as document review information generated by the analysis unit 113, editing data generated by the editing processing unit 115, translation data generated by a translation processing unit 116, and layout information generated by the first control unit 117 in response to a request from the terminal device T1.

The first storage unit 119 may store, for example, document data uploaded from the terminal device T1, document data of a new version generated from editing data by document editing processing, a support target document in a DOCX format, and additional information associated with each piece of document data.

In addition, the first storage unit 119 may store a first database and a second database. Here, the first database may be a database in which a plurality of pieces of alert information for calling attention of a user on the basis of the first standard regarding a content of a document unit constituting a document are registered. The plurality of pieces of alert information registered in the first database may be non-editable. In addition, the second database may be a database in which playbook information for calling attention of a user on the basis of the second standard regarding a content of the document unit constituting a document is registered. The playbook information registered in the second database may be editable by the editing processing.

### (Terminal Device T1)

For example, the terminal device T1 of the present embodiment may transmit and receives information regarding document display and document editing to and from the information processing device 10, for example, in a document browsing support service (the document browsing support system).

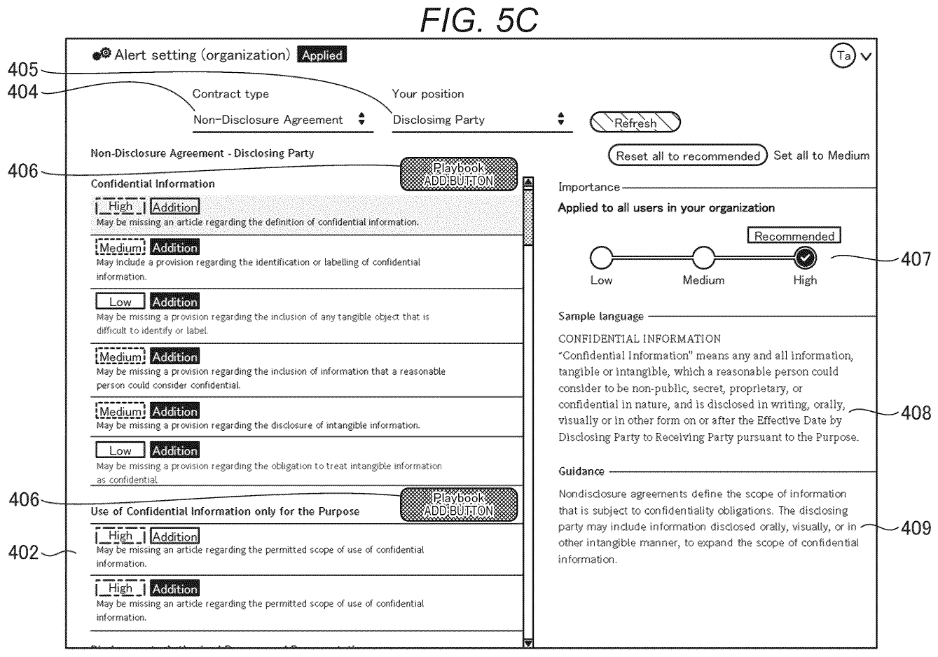

FIG. 7 is a block diagram illustrating an example of a hardware configuration of the terminal device T1 according to the embodiment. As illustrated in FIG. 7, the terminal device T1 may be a computer, and include, as an example, a processor 21, a main storage device (memory) 23, an auxiliary storage device (memory) 25, a network interface 27, a device interface 28, a bus 29 that connects the components to each other, a display device 30 connected to the device interface 28, and an input device 31 connected to the device interface 28. Note that specific hardware configurations of the processor 21, the main storage device 23, the auxiliary storage device 25, the network interface 27, the device interface 28, and the bus 29 may be similar to those of the processor 11, the main storage device 13, the auxiliary storage device 15, the network interface 17, the device interface 18, and the bus 19, respectively, and therefore description thereof is omitted.

The display device 30 may be a display device such as a liquid crystal display (LCD), a cathode ray tube (CRT), a plasma display panel (PDF), or an organic electro luminescence (EL) panel. The display device 30 may display, for example, a document review screen and a document editing screen described later on the basis of an instruction from the processor 21.

The input device 31 may be a device such as a keyboard, a mouse, or a touch panel. A user can input various editing instructions, for example, in the document editing processing by using the input device 31. The instruction input from the input device 31 may be sent to the processor 21.

Note that the terminal device T1 may include another external device (for example, a camera, a microphone, a motion capture, or various sensors) connected via the device interface 18 in order to operate and edit document data.

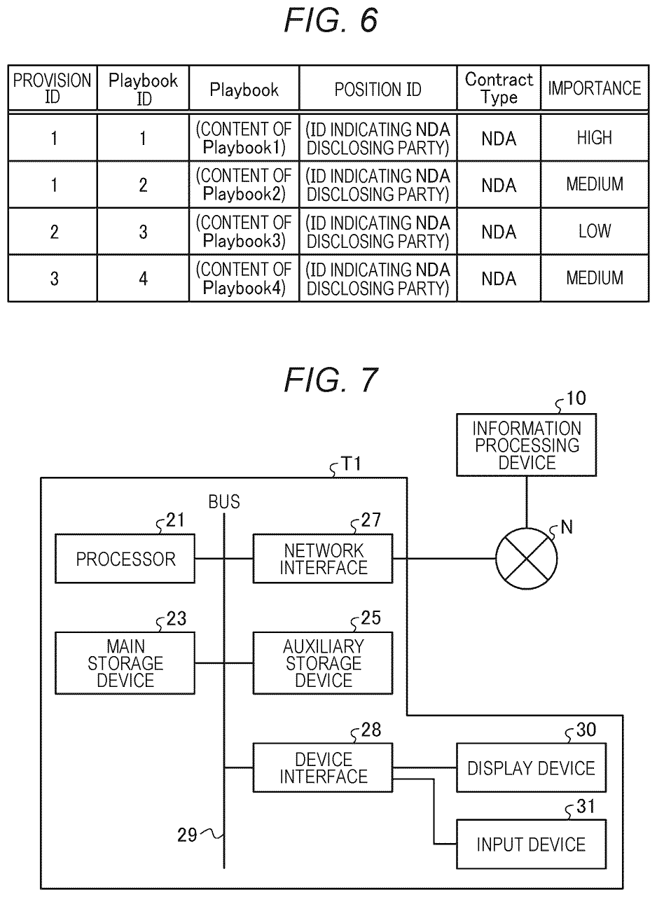

FIG. 8 is a diagram illustrating an example of functional blocks in the processor 21. The processor 21 may include, for example, a second control unit 40, a browser unit 42, and a second storage unit 44, as functions implemented by the processor 21. Functions implemented by the second control unit 40, the browser unit 42, and the second storage unit 44 may be stored as programs in, for example, the main storage device 23 or the auxiliary storage device 25. By reading and executing a program stored in the main storage device 23, the auxiliary storage device 25, or the like, the processor 21 can implement functions related to the second control unit 40 and the browser unit 42.

For example, the second control unit 40 may activate the browser unit 42 in response to an instruction from a user.

The browser unit 42 may be, for example, a general web browser, and executes processing according to hyper text markup language (HTML) data, a script (for example, JavaScript (registered trademark)), or the like. When being activated, the browser unit 42 may transmit an initial access URL to the information processing device 10 to make access.

The browser unit 42 of the present embodiment may display data including text data and image data received from the information processing device 10 on the display device 30 of the terminal device T1 in a predetermined form. More specifically, in the document review processing, the browser unit 42 may display document review information, document data, additional information, and the like received from the information processing device 10 on the display device 30 of the terminal device T1 in a predetermined form on the basis of layout information. In addition, in the document editing processing, the browser unit 42 of the present embodiment may display, for example, document review information, editing data, and additional information received from the information processing device 10 on the display device 30 of the terminal device T1 in a predetermined form on the basis of layout information.

In addition, for example, the browser unit 42 may transmit a translation start instruction from a user to the information processing device 10. For example, the browser unit 42 may receive playbook information registration screen information (including information for executing registration processing) from the first control unit 117 of the information processing device 10, and execute the registration processing and the like. For example, the browser unit 42 may receives a support target document that has been subjected to the registration processing, and store the support target document into the second storage unit 44.

The second storage unit 44 may store, for example, support target document data before editing processing and support target document data after the editing processing in a DOCX format acquired by the browser unit 42. In addition, the second storage unit 44 may store, for example, a playbook the receiving side of the document browsing support service has.

### [Playbook Information Registration Processing]

Next, playbook information registration processing implemented by the document browsing support system S will be described.

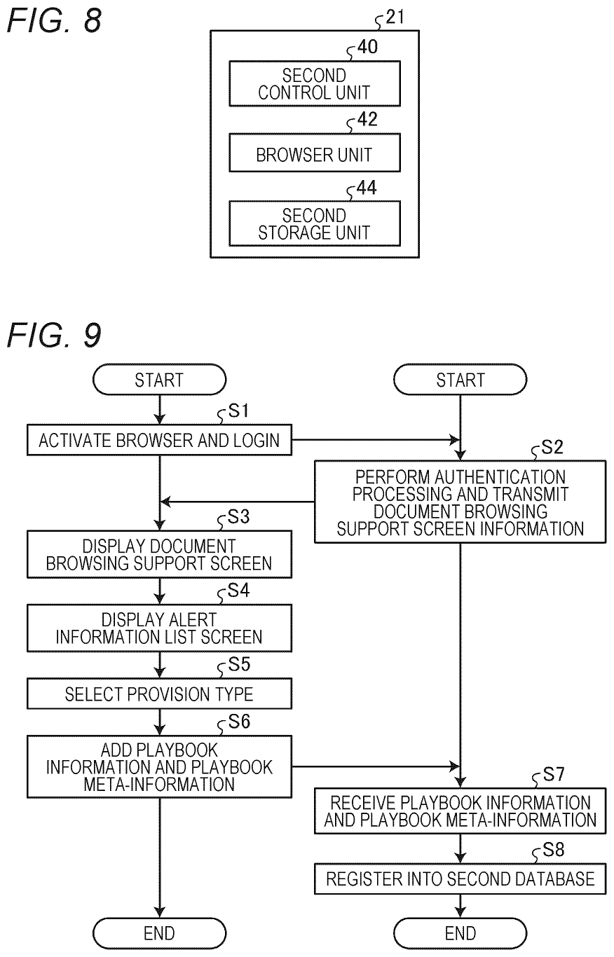

FIG. 9 is a flowchart illustrating an example of a flow of the playbook information registration processing. As illustrated in FIG. 9, first, the second control unit 40 of the terminal device T1 of the present embodiment may activate the browser unit 42 in response to an instruction from the user, for example. The browser unit 42 of the terminal device T1 may transmit, for example, login information such as an initial access URL or a registration ID to the information processing device 10 (step S1).

For example, the first control unit 117 of the information processing device 10 of the present embodiment may execute authentication processing in response to the login information from the terminal device T1. In addition, the first control unit 117 may transmit, for example, document browsing support screen information generated by the first control unit 117 (step S2).

For example, the browser unit 42 of the terminal device T1 of the present embodiment may cause the display device 30 to display a document browsing support screen on the basis of the document browsing support screen information received from the information processing device 10 (step S3).

The browser unit 42 of the terminal device T1 of the present embodiment may cause the display device 30 to display an alert list display screen in response to an instruction from the user (step S4).

For example, the browser unit 42 of the terminal device T1 of the present embodiment may receive selection of a provision type of a playbook information addition destination from the user on the alert list display screen (step S5). For example, in the example of the alert list display screen illustrated in FIG. 5, selection of the provision type of the playbook information addition destination may be received from the user in response to an operation of “Playbook Add Button” displayed corresponding to the provision type “Confidential Information”. With this step, as new alert information using the playbook, for example, information can be input and edited on the screen illustrated in FIGS. 5A and 5B.

In response to an instruction from the user, the browser unit 42 of the terminal device T1 of the present embodiment may receive addition (that is, writing to the first information area 408 and the like) of playbook information and playbook meta-information (step S6). The browser unit 42 of the terminal device T1 of the present embodiment may transmit the added playbook information and playbook meta-information to the information processing device 10.

The first control unit 117 of the information processing device 10 according to the present embodiment may receive the playbook information and the playbook meta-information transmitted from the terminal device T1 (step S7).

The registration unit 114 of the information processing device 10 according to the present embodiment may register the received playbook information and playbook meta-information into the second database of the first storage unit 119 (step S8).

According to the present embodiment, the user can add, on the alert list display screen, playbook information corresponding to a desired provision type together with playbook meta-information, to a database to be used in the review processing. Therefore, the user can easily customize the database for the review processing more suitable for a standard of the user.

### First Example of Second Review Processing

Next, a first example of the second review processing implemented by the document browsing support system S will be described. In the second review processing according to the first example, the review processing may be executed on the basis of the second standard. In the present embodiment, playbook information associated with a provision type may be present, and review processing using the associated playbook information is executed.

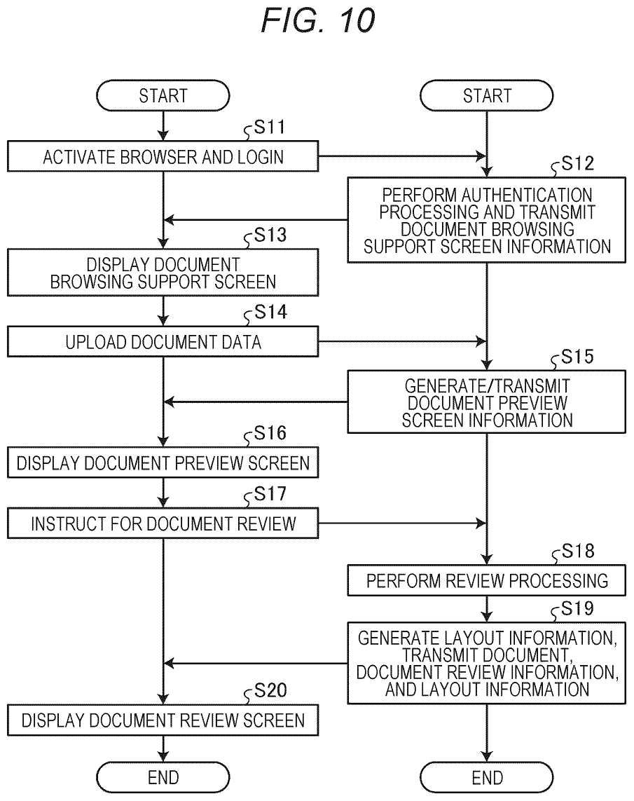

FIG. 10 is a flowchart illustrating a flow of document browsing support processing including the second review processing according to the first example. As illustrated in FIG. 10, first, the second control unit 40 of the terminal device T1 may activate the browser unit 42 in response to an instruction from a user. The browser unit 42 of the terminal device T1 may transmit, for example, login information such as an initial access URL or a registration ID to the information processing device 10 (step S11).

For example, the first control unit 117 of the information processing device 10 may execute authentication processing in response to the login information from the terminal device T1. In addition, the first control unit 117 may transmit, for example, document browsing support screen information generated by the first control unit 117 (step S12).

For example, the browser unit 42 of the terminal device T1 may display a document browsing support screen on the display device 30 on the basis of the document browsing support screen information received from the information processing device 10 (step S13).

For example, the browser unit 42 of the terminal device T1 may transmit support target document data to the information processing device 10 in response to a document upload instruction from the user (step S14).

The acquisition unit 111 of the information processing device 10 may store, for example, document data acquired (received) from the terminal device T1 in the first storage unit 119. For example, the first control unit 117 of the information processing device 10 may generate document preview screen information on the basis of the document data acquired by the acquisition unit 111. For example, the first control unit 117 of the information processing device 10 may transmit the generated document preview screen information to the terminal device T1 (step S15). Note that the document upload instruction and the storage of the document data in the first storage unit 119 may be performed, for example, by another user and/or another terminal of another department that requests a legal department to examine a contract document prior to editing processing. The document data may be subjected to determination of the document type of a support target document and analysis of the document unit.

For example, the browser unit 42 of the terminal device T1 may display a document preview screen on the basis of the document preview screen information received from the information processing device 10 (step S16). Note that, at this stage, since document review processing has not been performed, for example, only the support target document may be displayed on the document preview screen. By executing this step S16, the document browsing support system S of the present embodiment can be used not only for reviewing and editing a document but also for browsing a document. Note that the display of the document preview screen can be omitted, by receiving a document review instruction described later or performing document review processing before displaying the document preview screen.

The browser unit 42 of the terminal device T1 may transmit, for example, a document review instruction input from the user, to the information processing device 10 (step S17). At this time, for example, information regarding a user's position related to the support target document (for example, a position such as “Information Disclosing Party” or the like) may be also included in the document review instruction and transmitted.

An analysis unit 113 of the information processing device 10 may execute the second review processing in response to the document review instruction from the terminal device T1, and generate first review information and second review information (step S18). In the present embodiment, the second review information may not include the first review information.

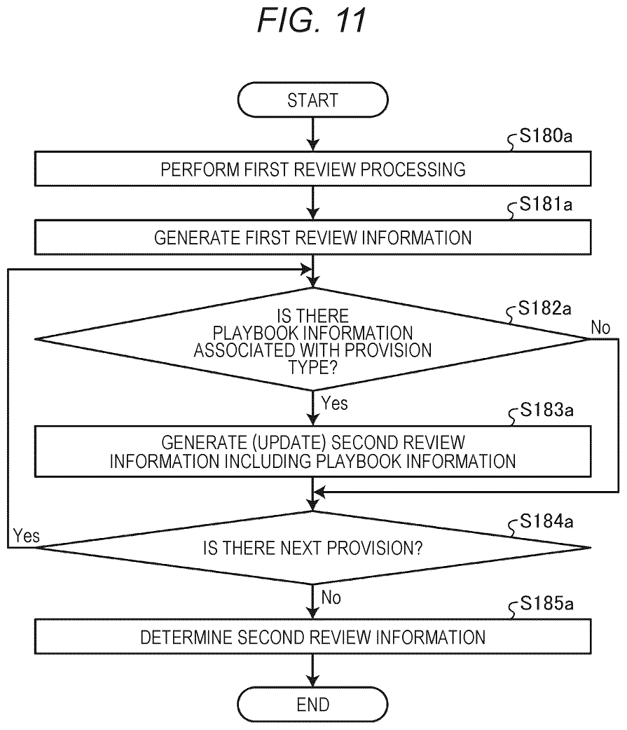

FIG. 11 is a flowchart illustrating a flow of the second review processing according to the first example. As illustrated in FIG. 11, the analysis unit 113 of the information processing device 10 may execute, by using the first database, for example, the first review processing (that is, for example, review processing executed on the basis of a highly versatile standard prepared by the providing side of the document browsing support service) (step S180a), and generate first review information regarding a support target document (step S181a). Note that a provision type included in the support target document may be analyzed simultaneously with or in advance of the generation of the first review information. The first review processing may be performed, for example, on the basis of the provision type and/or other information (for example, wording) included in support target document.

Next, the analysis unit 113 of the information processing device 10 may refer to the second database, and determines whether or not playbook information associated with the provision type is present (step S182a).

When it is determined that playbook information associated with the provision type is present (Yes in step S182a), the analysis unit 113 of the information processing device 10 may extract the associated playbook information and meta-information thereof (playbook meta-information), and generate second review information together with the first review information generated in step S181a (step S183a).

Whereas, when it is determined that playbook information associated with the provision type is not present (No in step S182a), the analysis unit 113 of the information processing device 10 may make a transition of the processing to step S184a.

The analysis unit 113 of the information processing device 10 may determine whether or not there is a next provision (step S184a). When it is determined that there is a next provision (Yes in step S184a), the analysis unit 113 of the information processing device 10 may repeatedly execute the processing in steps S182a to S184a to update the second review information. Whereas, when it is determined that there is no next provision (No in step S184a), the analysis unit 113 of the information processing device 10 may determine a content of the second review information (step S185a).

Note that the first review information and the second review information may not be necessarily generated in this order. For example, the first review information and the second review information may be generated simultaneously, or review information for a plurality of provision types may be generated in one step.

Returning to FIG. 10, the first control unit 117 of the information processing device 10 may generate layout information for displaying the first review information and the second review information in association with the support target document. The first control unit 117 of the information processing device 10 may transmit the support target document data, the first review information, the second review information, and the layout information generated by the first control unit 117 to the terminal device T1 (step S19).

The browser unit 42 of the terminal device T1 may display the document review screen on the basis of the support target document data, the second review information, and the layout information received from the information processing device 10 (step S20). That is, alert information according to the first standard and alert information according to the second standard (that is, the playbook) may be displayed as the document review screen together with information that allows distinguishment between the two, for example, in a form of being aligned with corresponding provisions as illustrated in FIG. 4A.

Note that a display order of playbook information included in the second review information on the document review screen can be controlled on the basis of, for example, importance and an update date and time included in the playbook meta-information. In addition, it may be also possible to switch between display and non-display of playbook information included in the second review information on the basis of at least one of a type of the support target document, importance of the provision, or a user's position.

In addition, the second review information may include status information indicating whether handling in the support target document is completed or uncompleted for alert information of each piece of playbook information. The status may also be changed on the document review screen in response to an input from the user.

### Second Example of Second Review Processing

Next, a second example of the second review processing implemented by the document browsing support system S will be described. In the second review processing according to the second example, in a case where playbook information associated with a provision type is present, the second review processing may be executed using playbook meta-information indicating attributes of the playbook information.

Hereinafter, for the sake of concrete explanation, a case where the second review processing is executed using “User's position” as the playbook meta-information will be described as an example. “User's position” is merely an example, and it may be also possible to execute the second review processing using the playbook meta-information such as “Language” or “Update date and time”. Further, the second review processing may be executed using a combination of a plurality of pieces of playbook meta-information.

Note that, in a case where the second review processing according to the first example is compared with the second review processing according to the second example, only a content of the second review processing shown in step S18 illustrated in FIG. 10 is different. Therefore, only the second review processing in step S18 will be described below.

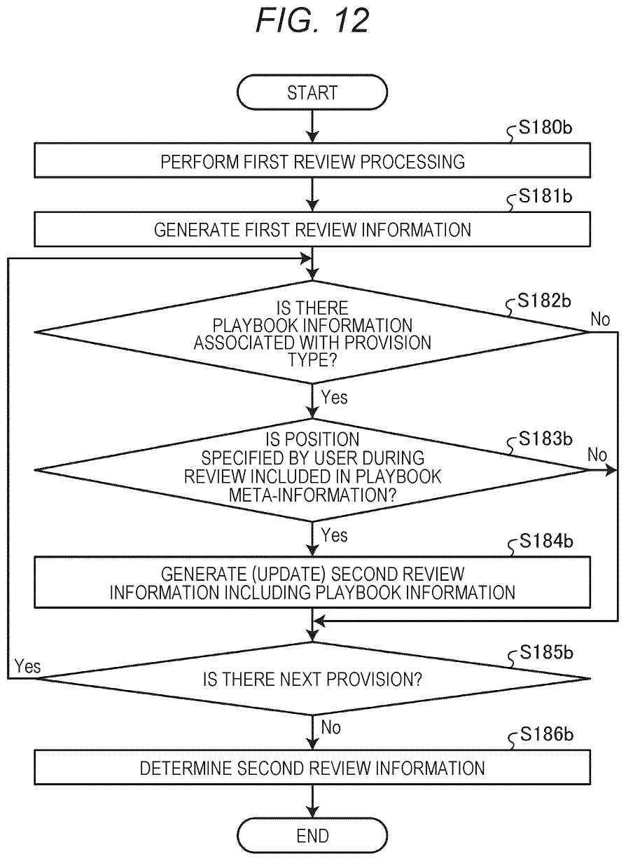

FIG. 12 is a flowchart illustrating a flow of the second review processing according to the second example, executed in step S18 of FIG. 10. As illustrated in FIG. 12, the analysis unit 113 of the information processing device 10 may execute, by using the first database, for example, the first review processing (that is, for example, review processing executed on the basis of a highly versatile standard prepared by the providing side of the document browsing support service) (step S180b), and generate first review information regarding a support target document (step S181b).

Next, the analysis unit 113 of the information processing device 10 may refer to the second database, and determine whether or not playbook information associated with a provision type is present (step S182b).

When it is determined that playbook information associated with the provision type is present (Yes in step S182b), the analysis unit 113 of the information processing device 10 may determine whether or not a user's position related to the support target document (for example, a position such as “Information Disclosing Party” of the document type “Non-Disclosure Agreement”) is present in meta-information of playbook information (playbook meta-information) associated with the provision type (step S183b).

When it is determined that the user's position related to the support target document is present in the playbook meta-information (Yes in step S183b), the analysis unit 113 of the information processing device 10 may extract the associated playbook information and playbook meta-information, and generate second review information together with the first review information generated in step S181b (step S184b).

Whereas, when it is determined that playbook information associated with the provision type is not present (No in step S182a), and when it is determined that the user's position related to the support target document may not be present in the playbook meta-information (No in step S183b), the analysis unit 113 of the information processing device 10 may make a transition of the processing to step S185b.

The analysis unit 113 of the information processing device 10 may determine whether or not there is a next provision (step S185b). When it is determined that there is a next provision (Yes in step S185b), the analysis unit 113 of the information processing device 10 may repeatedly execute the processing in steps S182b to S185b to update the second review information. Whereas, when it is determined that there is no next provision (No in step S185b), the analysis unit 113 of the information processing device 10 may determine a content of the second review information (step S186b).

According to the second review processing according to the second example, it may be possible to provide a user with second review information in which only playbook information matching a position related to a support target document is extracted. Therefore, it may be possible to support highly accurate and efficient review processing.

### Third Example of Second Review Processing

Next, a third example of the second review processing implemented by the document browsing support system S will be described. The second review processing according to the third example may generate second review information including all pieces of playbook information associated with individual provision types, in a case where a plurality of provision types are present in one provision (for example, two or more provision types such as “Effect of Right” and “Limitation on Effect of Right” are registered for one provision). Note that, in a case where the second review processing according to the first example is compared with the second review processing according to the third example, only a content of the second review processing shown in step S18 illustrated in FIG. 10 may be different. Therefore, only the second review processing in step S18 will be described below.

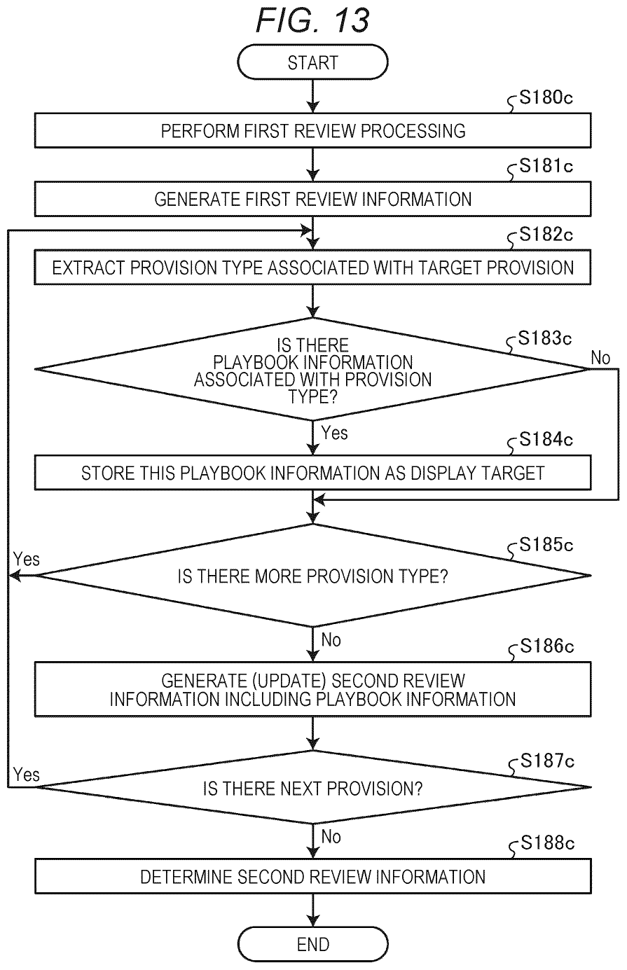

FIG. 13 is a flowchart illustrating a flow of the second review processing according to the third example, executed in step S18 of FIG. 10. As illustrated in FIG. 13, the analysis unit 113 of the information processing device 10 may execute, by using the first database, for example, the first review processing (that is, for example, review processing executed on the basis of a highly versatile standard prepared by the providing side of the document browsing support service) (step S180c), and generate first review information regarding a support target document (step S181c).

Next, the analysis unit 113 of the information processing device 10 may refer to the second database, for example, and extract a provision type associated with a target provision (step S182c).

The analysis unit 113 of the information processing device 10 may refer to the second database, and determine whether or not playbook information associated with the extracted provision type is present (step S183c).

When it is determined that playbook information associated with the provision type is present (Yes in step S183c), the analysis unit 113 of the information processing device 10 may store, as display targets, the playbook information associated with the provision type and meta-information thereof (playbook meta-information) into the first storage unit 119 (step S184c). Whereas, when it is determined that playbook information associated with the provision type is not present (No in step S183c), the analysis unit 113 of the information processing device 10 may make a transition of the processing to step S185c.

The analysis unit 113 of the information processing device 10 may refer to the second database, and determine whether or not there is more provision type associated with the target provision (step S185c).

When it is determined that there is more provision type associated with the target provision (Yes in step S185c), the analysis unit 113 of the information processing device 10 may repeatedly execute the processing in steps S182c to S185c, and store the playbook information for each provision type. Whereas, when it is determined that there is no more provision type associated with the target provision (No in step S185c), the analysis unit 113 of the information processing device 10 may generate second review information by combining the playbook information and the playbook meta-information stored in step S184c with the first review information generated in step S181c (step S186c).

The analysis unit 113 of the information processing device 10 may determine whether or not there is a next provision (step S187c). When it is determined that there is a next provision (Yes in step S187c), the analysis unit 113 of the information processing device 10 may repeatedly execute the processing in steps S182c to S187c to update the second review information. Whereas, when it is determined that there is no next provision (No in step S187c), the analysis unit 113 of the information processing device 10 may determine a content of the second review information (step S188c).

According to the second review processing according to the third example, even when a plurality of provision types are present in one provision, the second review information including all pieces of playbook information associated with individual provision types can be generated. Therefore, it may be possible to support highly accurate and efficient review processing.

The information processing device 10 according to the present embodiment may include the first database, the second database, the acquisition unit 111, the analysis unit 113, and the first control unit 117. The first database may be, for example, an alert information database in which a plurality of pieces of alert information are registered for individual types of document unit, in which the alert information is for calling attention of a user on the basis of the first standard (for example, a highly versatile standard prepared by the providing side of the document browsing support service) regarding a content of the document unit constituting a document. The second database may be, for example, a playbook information database in which a plurality of pieces of playbook information are registered for individual types of the document unit, in which the playbook information is for calling attention of a user on the basis of the second standard (for example, a unique (individual) standard on the receiving side of the document browsing support service) regarding a content of the document unit constituting a document. The acquisition unit 111 may acquire a support target document. The analysis unit 113 may extract at least one piece of alert information from the alert information database on the basis of a type of a support target document unit constituting the support target document, and extract at least one piece of playbook information from the playbook information database on the basis of the type of the support target document unit constituting the support target document. Then, the analysis unit 113 may execute second review processing on the support target document to generate second review information including the extracted alert information and the extracted playbook information. The first control unit 117 may cause the display device 30 of the terminal device T1 to display the second review information and the corresponding support target document unit.

Therefore, the user can execute the review processing using not only the highly versatile standard prepared by the providing side of the document browsing support service but also the unique (individual) standard registered as playbook information, and can check the result. As a result, it is possible to provide a support technology for implementing automatic review processing using an individual standard for a document.

In addition, according to the information processing device 10 according to the embodiment, as playbook information, any content can be registered in the second database at any timing for each type (provision type) of a document unit. Therefore, the user can freely customize the playbook information, and can execute the second review processing using a unique (individual) standard. As a result, it may be possible to provide a support technology for implementing automatic review processing with a high degree of freedom.

In addition, according to the information processing device 10 according to the embodiment, in registration of playbook information, the playbook information can be registered in association with related alert information, from a list display screen of the alert information in which a plurality of pieces of alert information are displayed for individual types of a document unit. In addition, in registration of playbook information, the playbook information can also be registered in association with related alert information, from a display screen of review information displayed by executing review processing on a support target document. Therefore, the user can register playbook information while checking the document unit type (provision type) to be associated and a content of the related alert information based on the first standard.

In addition, according to the information processing device 10 according to the embodiment, playbook information can be registered in association with at least one attribute among a type of the support target document, importance of each document segment, a user's position, and an update date and time.

A display order of playbook information included in the second review information on the document review screen can be controlled on the basis of, for example, the importance and the update date and time included in the playbook meta-information. In addition, playbook information included in the second review information can be filtered to be displayed on the basis of at least one of the type of the support target document, the importance of the provision, and the user's position.

Therefore, the user can display only playbook information narrowed down by a desired condition (playbook meta-information). As a result, it may be possible to provide a support technology for implementing the review processing with a high degree of freedom and high accuracy.

In addition, the second review information may include status information indicating whether handling of each piece of playbook information is completed or uncompleted. The status can also be changed on the document review screen in response to an input from the user.

Therefore, the user can perform status management for each piece of playbook information. As a result, it may be possible to provide review processing based on a unique standard with good usability.

### Second Embodiment

Next, a document browsing support system S according to a second embodiment will be described. The document browsing support system S according to the second embodiment may register playbook information by using, for example, a document before correction and a document after correction, for a support target document.

Here, the document before correction of the support target document of the present embodiment (hereinafter, also simply referred to as “document before correction”) may be a document (for example, a first version document) in which a manager, a responsible person, or the like has not made content correction, content addition, content deletion, and addition of comments or the like in the support target document. In addition, the document after correction of the support target document (hereinafter, also simply referred to as “document after correction”) may be a document (for example, a final version document) after the manager, the responsible person, or the like has made content correction, content addition, content deletion, and addition of comments or the like in the support target document. Note that the document before correction and the document after correction are not limited to the above. In a case where a certain document is set as the document after correction, any document of a previous version may be set as the document before correction. In addition, in a case where a certain document is set as the document after correction, a template of that document may be set as the document before correction. That is, any document before correction and document after correction can be used as long as a difference enabling generation of playbook information can be obtained between the document before correction and the document after correction, and the document after correction may not necessarily be created on the basis of the document before correction. Since the final version of the document generally has a content of which document review has been completed, and is often considered to be preferable in a user's position, it may be possible to generate appropriate playbook information by setting the final version of the document as the document after correction.

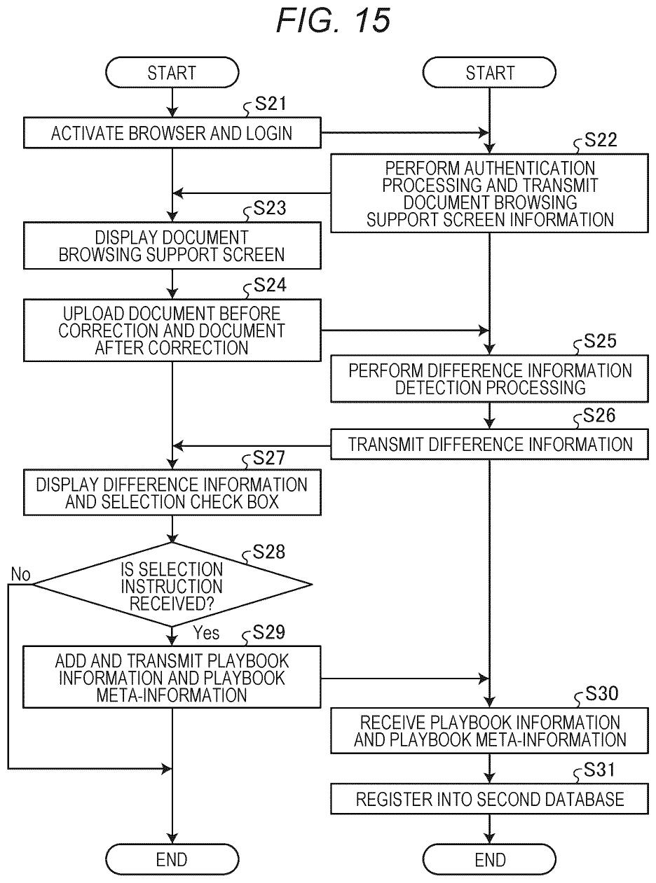

FIG. 15 is a flowchart illustrating an example of a flow of playbook information registration processing according to the second embodiment. As illustrated in FIG. 15, first, a second control unit 40 of a terminal device T1 of the present embodiment may activate a browser unit 42 in response to an instruction from a user, for example. The browser unit 42 of the terminal device T1 may transmit, for example, login information such as an initial access URL or a registration ID to an information processing device 10 (step S21).

For example, a first control unit 117 of the information processing device 10 of the present embodiment may execute authentication processing in response to the login information from the terminal device T1. In addition, the first control unit 117 may transmit, for example, document browsing support screen information generated by the first control unit 117 (step S22).

For example, the browser unit 42 of the terminal device T1 of the present embodiment may cause a display device 30 to display a document browsing support screen on the basis of the document browsing support screen information received from the information processing device 10 (step S23).

For example, the second control unit 40 of the terminal device T1 may transmits the document before correction and the document after correction to the information processing device 10 in response to an upload instruction from the user (step S24).

An acquisition unit 111 of the information processing device 10 may store, for example, the document before correction and the document after correction received from the terminal device T1 into a first storage unit 119. A registration unit 114 of the information processing device 10 may execute difference information detection processing using the document before correction and the document after correction (step S25).

Here, the difference information detection processing may be processing of detecting a difference in content between the document before correction and the document after correction and generating difference information indicating a content of the difference. Therefore, the difference information may be information including what kind of information has been corrected, added, or deleted, what kind of comment has been added, or the like with respect to the document before correction. The difference information detection processing may be executed by, for example, dividing each of the document before correction and the document after correction into document units such as parts, sections, paragraphs, and items and matching individual corresponding document units on the basis of a provision type, and generating difference information for the individual document units when there is a difference. In addition, the difference information can also include a difference in meta-information such as a document type and a language given to the document before correction and the document after correction.

The first control unit 117 of the information processing device 10 may transmit the generated difference information to the terminal device T1 (step S26).

The browser unit 42 of the terminal device T1 may cause the display device 30 to display a registration necessity selection screen including the received difference information and a selection check box for instructing selection of whether or not to register playbook information using the difference information (step S27).

When the browser unit 42 of the terminal device T1 receives a selection instruction of “not registering playbook information using the difference information” via the selection check box (No in step S27), the browser unit 42 may end the playbook information registration processing. Whereas, when the browser unit 42 of the terminal device T1 receives a selection instruction of “registering playbook information using the difference information” via the selection check box (Yes in step S27), the browser unit 42 may transmit the selection instruction to the information processing device 10.

The first control unit 117 of the information processing device 10 may receive the selection instruction of “registering playbook information using the difference information” from the terminal device T1 (step S29), and classify the difference information for each document unit by a provision type and registers the classified difference information into the second database as playbook information (step S30).

According to the second embodiment, the user can automatically register new playbook information into the second database by uploading the document before correction and the document after correction of the support target document. Therefore, it may be possible to reduce a workload on the user as compared with a case of making desired selection from the alert information list and registering playbook information via the GUI illustrated in FIG. 5C.

Note that, to obtain the playbook information, a change such as editing may be performed on the difference information by the user or the system. In this case, the change may be made on the registration necessity selection screen. In addition, when the playbook information is registered, other information (for example, playbook meta-information) or the like may be registered together.

### (Modification 1)

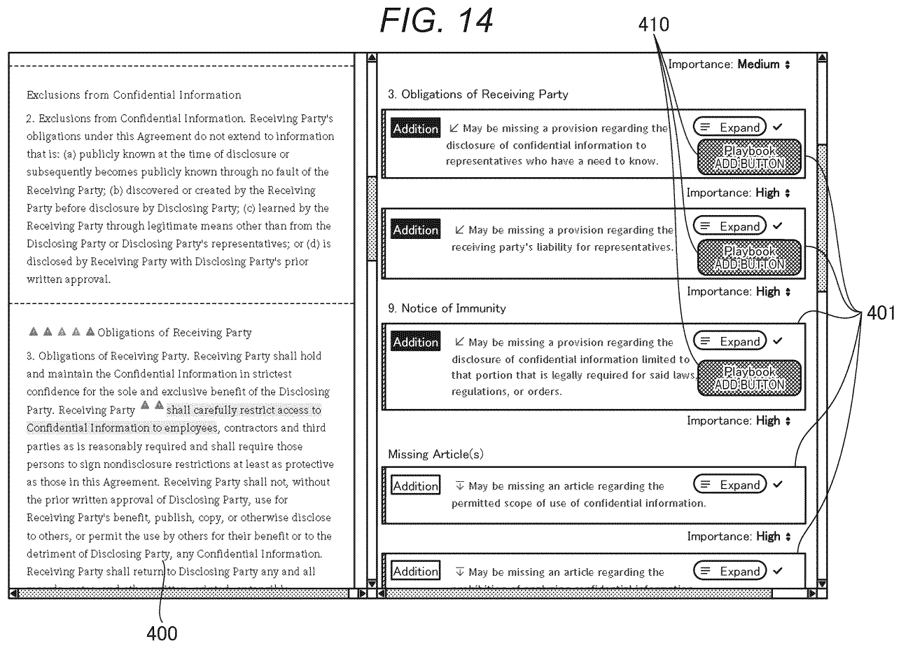

In the first embodiment, as illustrated in FIG. 5C, the GUI has been exemplified in which “Playbook Add Button” is provided for each provision type on the display screen of the alert information list. Whereas, in the review information display screen illustrated in FIG. 4A, as illustrated in FIG. 14, “Playbook Add Button” may be provided in each piece of alert information, and playbook information and playbook meta-information may be edited and registered by operating “Playbook Add Button”.

### (Modification 2)

In the first embodiment, a case is exemplified in which the GUI for the user to register playbook information is displayed on the screen, and the playbook information is registered in the second database from the GUI. Whereas, for example, in registration of playbook information, a document segment type (provision type) to be associated with each piece of the playbook information may be determined using a learned model, and the playbook information may be registered in the second database in association with at least one determined document segment type. Note that, in a case where the determined document segment type is not appropriate or the like, the playbook information may be associated with another document segment type selected by the user.

### (Modification 3)

Some or all of the devices in the above-described embodiments may be configured by hardware, or may be configured by information processing of software (program) executed by a CPU, a GPU, or the like. In addition, in the above embodiments, when a plurality of storage devices store data, each of the plurality of storage devices may store only a part of the data or may store the entire data.

An information processing method according to an embodiment may be an information processing method using: a first database in which a plurality of pieces of alert information for calling attention of a user based on a first standard regarding a content of a document unit constituting a document are registered for individual types of the document unit; and a second database in which a plurality of pieces of playbook information for calling attention of a user based on a second standard regarding a content of a document unit constituting a document are registered for individual types of a document unit, and the information processing method includes: acquiring a support target document; extracting at least one piece of the alert information from the first database based on a type of a support target document unit constituting the support target document; extracting at least one piece of the playbook information from the second database based on a type of a support target document unit constituting the support target document; executing review processing on the support target document to generate review information including among the extracted alert information and the extracted playbook information; and causing a display device to display the review information and the support target document unit corresponding to the review information.

An information processing method according to an embodiment may be an information processing method using a first database in which a plurality of pieces of alert information for calling attention of a user based on a first standard regarding a content of a document unit constituting a document are registered for individual types of the document unit, and the information processing method includes: generating a second database by registering, for individual types of a document unit, a plurality of pieces of playbook information for calling attention of a user based on a second standard regarding a content of a document unit constituting a document; acquiring a support target document; extracting at least one piece of the alert information from the first database based on a type of a support target document unit constituting the support target document; extracting at least one piece of the playbook information from the second database based on a type of a support target document unit constituting the support target document; executing review processing on the support target document to generate review information including the extracted alert information and the extracted playbook information; and causing a display device to display the review information and the support target document unit corresponding to the review information.

An information processing program according to an embodiment may cause a computer to use: a first database in which a plurality of pieces of alert information for calling attention of a user based on a first standard regarding a content of a document unit constituting a document are registered for individual types of the document unit; and a second database in which a plurality of pieces of playbook information for calling attention of a user based on a second standard regarding a content of a document unit constituting a document are registered for individual types of a document unit, to implement functions of: acquiring a support target document; extracting at least one piece of the alert information from the first database based on a type of a support target document unit constituting the support target document; extracting at least one piece of the playbook information from the second database based on a type of a support target document unit constituting the support target document; executing review processing on the support target document to generate review information including among the extracted alert information and the extracted playbook information; and causing a display device to display the review information and the support target document unit corresponding to the review information.

An information processing program according to an embodiment may cause a computer to use a first database in which a plurality of pieces of alert information for calling attention of a user based on a first standard regarding a content of a document unit constituting a document are registered for individual types of the document unit, to implement functions of: generating a second database by registering, for individual types of a document unit, a plurality of pieces of playbook information for calling attention of a user based on a second standard regarding a content of a document unit constituting a document; acquiring a support target document; extracting at least one piece of the alert information from the first database based on a type of a support target document unit constituting the support target document; extracting at least one piece of the playbook information from the second database based on a type of a support target document unit constituting the support target document; executing review processing on the support target document to generate review information including the extracted alert information and the extracted playbook information; and causing a display device to display the review information and the support target document unit corresponding to the review information.

Although the embodiments of the present disclosure have been described in detail above, these embodiments have been presented as examples, and are not intended to be limited to individual embodiments. The embodiments can be modified by various additions, changes, replacements, partial deletions, combinations, and the like without departing from the technical idea of the present invention. These embodiments and modifications thereof are included in the invention described in the claims and an equivalent scope thereof.

What is claimed is:

1. An information processing method comprising:
extracting at least one piece of alert information, based on a support target document, from a first database including a plurality of pieces of the alert information for calling attention of a user based on a first standard regarding a content of a document unit constituting a document;
extracting at least one piece of playbook information, based on the support target document, from a second database in which the playbook information is registered, the playbook information being for calling attention of a user based on a second standard regarding a content of a document unit constituting a document, and the playbook information being editable in the second database; and
generating review information including the playbook information.

2. An information processing method using a first database in which a plurality of pieces of alert information for calling attention of a user based on a first standard regarding a content of a document unit constituting a document are registered for individual types of the document unit,
the information processing method comprising:
editing a second database by registering, for individual types of a document unit, a plurality of pieces of playbook information for calling attention of a user based on a second standard regarding a content of the document unit constituting a document;
acquiring a support target document;
extracting at least one piece of the alert information from the first database based on a type of a support target document unit constituting the support target document;
extracting at least one piece of the playbook information from the second database based on a type of a support target document unit constituting the support target document;
executing review processing on the support target document to generate review information including the extracted alert information and the extracted playbook information; and
causing a display device to display the review information and the support target document unit corresponding to the review information.

3. The information processing method according to claim 2, comprising:
registering the playbook information in association with the alert information that is related, from a display screen on which the plurality of pieces of alert information are displayed for individual types of the document unit, in registration of the playbook information.

4. The information processing method according to claim 2, comprising:
registering the playbook information in association with the alert information that is related, from a display screen of review information displayed by executing review processing on the support target document, in registration of the playbook information.

5. The information processing method according to claim 2, comprising:
inputting the acquired playbook information to a learned model and determining the type of at least one of the document units to be registered; and
registering the acquired playbook information into a second database in association with the determined type of at least one of the document units,
in registration of the playbook information.

6. The information processing method according to claim 2, comprising:
generating the playbook information based on difference information between a document before correction and a document after correction, in registration of the playbook information.

7. The information processing method according to claim 1, wherein
the support target document is a legal document; and
the document unit is a unit of a provision.

8. The information processing method according to claim 2, wherein
the playbook information is registered in association with at least one attribute among a type of the support target document, importance of the support target document unit, a user's position, and an update date and time, and
the review processing is executed based on the attribute.

9. The information processing method according to claim 8, comprising:
determining a display order of the playbook information included in the review information, based on the importance.

10. The information processing method according to claim 8, comprising:
determining a display order of the playbook information included in the review information, based on the update date and time.

11. The information processing method according to claim 8, comprising:
filtering the playbook information included in the review information, based on at least one of the type of the support target document, the importance of the support target document unit, or the user's position.

12. The information processing method according to claim 1, further comprising:
the review information includes status information indicating completion or incompletion with respect to the playbook information, and
changing the status information in response to an input from a user.

13. The information processing method according to claim 2, further comprising:
dividing the acquired support target document into a plurality of the support target document units; and
determining the type for each of the plurality of support target document units.

14. The information processing method according to claim 1, wherein
the review information includes information for distinguishing the alert information and the playbook information.

15. An information processing device comprising:
a first database in which a plurality of pieces of alert information for calling attention of a user based on a first standard regarding a content of a document unit constituting a document are registered;
a second database in which playbook information for calling attention of a user based on a second standard regarding a content of a document unit constituting a document is registered;
an analysis unit that extracts at least one piece of the alert information from the first database based on a support target document, extracts at least one piece of the playbook information from the second database based on the support target document, and generates review information including the playbook information; and
a control unit that causes an output device to output the review information and the support target document unit corresponding to the review information.
